(19) United States
(12) Patent Application Publication
(10) Pub. No.: US 2011/0043684 A1
(43) Pub. Date: Feb. 24, 2011

(54) Imaging device and method of producing the same

(75) Inventors: Hideaki Fujita, Shiki-Gun (JP); Masayuki Nishikawa, Higashiosaka-Shi (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 12/310,755

(22) PCT Filed: Sep. 10, 2007
(86) PCT No.: PCT/JP07/67582

§ 371 Date: Nov. 9, 2009

(30) Foreign Application Priority Data
Sep. 8, 2006 (JP) 2006-244217
Jun. 12, 2007 (JP) 2007-155067

(51) Int. Cl. H04N 5/225; G02B 7/04

(52) U.S. Cl. 348/374; 359/824; 348/E05.024

(57) ABSTRACT

An imaging device comprises: a lens housing on which lens groups are mounted and which has a first opening opened along an optical axis direction of the lens groups; and a drive housing on which a drive source for moving the lens groups in the optical axis direction is mounted and which has a drive-use opening to be communicated with the first opening of the lens housing. The lens housing and the drive housing are combined together so as to be separable from each other in a state that the first opening and the drive-use opening are communicated with each other.

### TECHNICAL FIELD

The present invention relates to an imaging device and, more specifically, to an imaging device including lens groups and a driver part for moving the lens groups in an optical axis direction thereof.

Also, the present invention relates to a production method for an imaging device by which such an imaging device is assembled.

### BACKGROUND ART

There has been widely spread an imaging device (camera) which is so structured that a subject image to be formed based on light flux incident on an image pickup optical system composed of plural lens groups is focused on an image sensor such as a charge coupled device (CCD) placed at specified position. In this type of imaging device, an autofocus function and a zoom function can be fulfilled by moving the plural lens groups along an optical axis direction thereof. For movement of the lenses in the optical axis direction, generally used is a method in which with use of a stepping motor as a drive source, a lens holding frame is driven in the optical axis direction via transmission means such as a reduction gear and a lead screw.

An imaging device having those autofocus and zoom functions, generally, has a structure that a lens driving source and an image sensor together with the lens groups are accommodated in a lens housing (see, e.g., FIG. 1 of JP H4-369608 A).

On the other hand, there has been known an imaging device in which a mechanical shutter for adjusting light quantity in response to a brightness of a subject is fixed to a lens holding frame and the mechanical shutter is moved integrally with the lens holding frame (see, e.g., FIGS. 3 and 4 of JP H5-134159 A). In such an imaging device, a flexible printed circuit board (FPC) for controlling opening and closing of the mechanical shutter needs to be drawn out from a lens housing. Further, an origin sensor such as a photo interrupter (PI) is used to detect a position of the lens holding frame.

### DISCLOSURE OF INVENTION

### Technical Problem to be Solved

In the construction of the imaging device disclosed in JP H4-369608 A, the lens driving source is accommodated in the lens housing. Therefore, vibrations of the lens driving source are transferred directly to the lens housing, posing a problem that vibrations or drive noise of the lens groups is increased. Moving precision of the lens groups is also lowered. If the rigidity of the lens housing is increased as a countermeasure for reduction of the vibrations, there would arise a problem of scale-up of the lens housing or cost increase. Further, with a construction that the lens driving source is accommodated in the lens housing, occurrence of a failure in the driving unit or the lens groups assembly, if any, would require time and labor for removal of related members, leading to a difficulty of reworking as another problem. These problems would have even greater effects, in particular, on imaging devices that require a plurality of drive sources for zoom and autofocus functions.

In the imaging device having a mechanical shutter and a photo interrupter as disclosed in JP H5-134159 A, there is a difficulty in assembly or reworking due to draw-out of the flexible printed circuit board (FPC) or the way of electrical conduction.

Accordingly, an object of the present invention is to provide an imaging device which is capable of reducing its size, price and noise, moving the lens groups with high precision, and facilitating its assembly and reworking.

Another object of the invention is to provide an production method for an imaging device by which such an imaging device is assembled.

### Solution to Problem

In order to achieve the object, an imaging device of the present invention comprises:

a lens housing on which lens groups are mounted and which has a first opening opened along an optical axis direction of the lens groups; and

a drive housing on which a drive source for moving the lens groups in the optical axis direction is mounted and which has a drive-use opening to be communicated with the first opening of the lens housing, wherein

the lens housing and the drive housing are combined together so as to be separable from each other in a state that the first opening and the drive-use opening are communicated with each other.

According to the imaging device of this invention, the lens housing and the drive housing are combined together in a state that the first opening and the drive-use opening are communicated with each other. Therefore, the lens groups can be moved in the optical axis direction by transmitting driving force, which is derived from the drive source mounted on the drive housing, to the lens groups mounted on the lens housing through the first opening and the drive-use opening communicated with each other. In such a case, vibrations from the drive source are transferred only indirectly to the lens housing via the drive housing, so that vibrations from the drive source can be prevented from being transferred directly to the lens housing. Thus, a noise reduction can be achieved. Further, since vibration transfer to the lens housing is suppressed, it is possible to move the lens groups with high precision.

Also, since the imaging device is made up basically by combining the lens housing and the drive housing together, its assembly is easily achievable. Still, since the lens housing and the drive housing are separable from each other, reworking is facilitated.

Furthermore, since the lens housing does not need to be enhanced particularly in rigidity, the imaging device does not incur upsizing or cost increases, and allows downsizing and price cuts to be achieved.

Moreover, when a closed structure to surround peripheries of the first opening and the drive-use opening communicated with each other is made up by the lens housing and the drive housing or by additionally combining other members, invasion of contaminations from outside to inside of the imaging device can be easily prevented.

In the imaging device of one embodiment, in addition to the drive source, a transmission mechanism for transmitting driving force derived from the drive source to the lens groups is mounted on the drive housing.

According to the imaging device of this one embodiment, driving force derived from the drive source mounted on the drive housing can be transmitted via the transmission mechanism to the lens groups mounted on the lens housing.

In the imaging device of one embodiment, the drive source and the transmission mechanism are internally contained in the drive housing.

According to the imaging device of this one embodiment, since the drive source and the transmission mechanism are internally contained in the drive housing, vibration transfer to the lens housing is further suppressed and moreover drive noise is further reduced.

In the imaging device of one embodiment,

the lens housing has, in addition to the first opening, a second opening which allows inside of the lens housing to be observed, and

a removable plate member for closing the second opening is included.

According to the imaging device of this one embodiment, the lens housing has, in addition to the first opening, a second opening which allows inside of the lens housing to be observed. Therefore, at this production stage of the imaging device, after the lens housing and the drive housing are combined with each other and before the plate member is fitted, the inside of the lens housing can be observed from the outside of the lens housing through the second opening. Accordingly, it becomes possible, for example, to observe drive characteristics of the lens groups from outside and simply make a good/no-good decision after the assembly of the lens housing and the drive housing. Thus, in case that drive characteristics of the lens groups are no good, reworking is easily performed.

In the imaging device of one embodiment,

the lens groups include at least two lens groups enabled to move along the optical axis direction independently of each other,

the drive source includes first and second motors for moving the two lens groups, respectively, along the optical axis direction independently of each other, and

the first motor and the second motor are apposed along the optical axis direction on the drive housing.

According to the imaging device of this one embodiment, since the lens groups include at least two lens groups enabled to move along the optical axis direction, respectively on the lens housing, autofocus function and zoom function can be easily fulfilled. Also, since the first motor and the second motor are apposed along the optical axis direction, a space can be saved with respect to a direction vertical to the optical axis direction, allowing the imaging device to be downsized.

In the imaging device of one embodiment,

a mechanical shutter for adjusting light quantity in response to a brightness of a subject is mounted on the lens housing, and

a control-use flexible printed circuit board for feeding power to the mechanical shutter is drawn out of the lens housing from one side of the lens housing opposite to a first opening side with respect to the optical axis of the lens groups.

According to the imaging device of this one embodiment, a control-use flexible printed circuit board for feeding power to the mechanical shutter is drawn out of the lens housing from one side of the lens housing opposite to a first opening side with respect to an optical axis of the lens groups (where it is assumed that the mechanical shutter and the control-use flexible printed circuit board are preliminarily mounted on the lens housing prior to the combining of the lens housing and the drive housing). Therefore, at this production stage of the imaging device, when the lens housing and the drive housing are combined together, the control-use flexible printed circuit board makes no obstacle to the assembling work. Also, since the drive housing (as well as members mounted thereon) is not placed on one side of the lens housing opposite to the first opening side with respect to the optical axis of the lens groups, there is a space essentially for placement of such members as the control-use flexible printed circuit board. Therefore, with a configuration that the control-use flexible printed circuit board is drawn out of the lens housing from one side of the lens housing opposite to the first opening side with respect to the optical axis of the lens groups as in the imaging device of this one embodiment, such a space is effectively exploited, thus making it possible to downsize the imaging device.

In the imaging device of one embodiment, the control-use flexible printed circuit board for feeding power to the mechanical shutter has an expanding-and-contracting portion which is deformed as one of the lens groups moves in the optical axis direction, and the expanding-and-contracting portion is placed within the lens housing on one side of the lens housing opposite to a first opening side with respect to the optical axis of the lens groups.

According to the imaging device of this one embodiment, providing the expanding-and-contracting portion of the control-use flexible printed circuit board allows the lens group to be moved smoothly, and moreover placing the expanding-and-contracting portion within the lens housing allows the assembly workability to be enhanced. Also, since the drive housing (as well as members mounted thereon) is not placed on the side of the lens housing opposite to the first opening side with respect to the optical axis of the lens groups, there is a space essentially for placement of such members as the control-use flexible printed circuit board. Therefore, with a configuration that the expanding-and-contracting portion of the control-use flexible printed circuit board is placed on one side of the lens housing opposite to the first opening side with respect to the optical axis of the lens groups as in the imaging device of this one embodiment, such a space is effectively exploited.

In the imaging device of one embodiment, an origin sensor for detecting a position of the lens groups is mounted on one side of the lens housing opposite to a first opening side with respect to the optical axis of the lens groups.

According to the imaging device of this one embodiment, an origin sensor for detecting a position of the lens groups is mounted on one side of the lens housing opposite to a first opening side with respect to the optical axis of the lens groups (where it is assumed that the origin sensor is preliminarily mounted on the lens housing prior to the combining of the lens housing and the drive housing). Therefore, at this production stage of the imaging device, when the lens housing and the drive housing are combined together, the origin sensor makes no obstacle to the assembling work. Also, since the drive housing (as well as members mounted thereon) is not placed on one side of the lens housing opposite to the first opening side with respect to the optical axis of the lens groups, there is a space essentially for placement of such members as the origin sensor. Therefore, with a configuration that the origin sensor is mounted on one side of the lens housing opposite to the first opening side with respect to the optical axis of the lens groups as in the imaging device of this one embodiment, such a space is effectively exploited, thus making it possible to downsize the imaging device.

In the imaging device of one embodiment,

an origin sensor for detecting a position of the lens groups is mounted on one side of the lens housing opposite to a first opening side with respect to the optical axis of the lens groups, and

the control-use flexible printed circuit board for feeding power to the mechanical shutter includes a flexible printed circuit board for feeding power to the origin sensor.

According to the imaging device of this one embodiment, since the control-use flexible printed circuit board for the mechanical shutter includes a flexible printed circuit board for feeding power to the origin sensor, the flexible printed circuit boards associated with members placed within the lens housing can be collectively managed, facilitating the leading work of the control-use flexible printed circuit boards from the lens housing, hence a bettered assemblability. Also, component parts count can be cut down, so that a cost reduction can be achieved.

In the imaging device of one embodiment, a drive-use flexible printed circuit board for feeding power to the drive source is connected to the control-use flexible printed circuit board via a removable connecting-use connector.

According to the imaging device of this one embodiment, flexible printed circuit boards in the lens housing and flexible printed circuit boards drawn out from the drive housing are connected together, respectively, by the removable connecting-use connector. Therefore, in case that a failure is found in the lens housing or the drive housing after their coupling, the flexible printed circuit boards can be easily divided, making it possible to further enhance the reworkability.

In the imaging device of one embodiment,

the lens housing has, in addition to the first opening, a second opening which allows inside of the lens housing to be observed,

a removable plate member for closing the second opening is included, and

the removable connecting-use connector is placed along an outer surface of the plate member.

According to the imaging device of this one embodiment, since the connecting-use connector is placed not on the lens housing or the drive housing but on the lower-priced plate member, it becomes possible to fulfill reworking only by replacement of the lower-priced plate member, so that the reworking can be done with even lower cost.

In the imaging device of one embodiment, the plate member is formed from a metallic material.

Since the plate member is formed from a metallic material such as stainless or aluminum, which is higher in rigidity than resin materials, deformation of the plate member can be prevented during the connecting work of the connecting-use connector. Also, since the plate thickness can be thinned, the imaging device can be downsized.

A production method for an imaging device of the present invention comprises:

preparing a lens housing on which lens groups are mounted and which has a first opening opened along an optical axis direction of the lens groups, and

a drive housing on which a drive source for moving the lens groups in the optical axis direction and a transmission mechanism for transmitting driving force derived from the drive source to the lens groups are mounted and which has a drive-use opening to be communicated with the first opening of the lens housing; and

combining the lens housing and the drive housing together separably from each other in a state that the first opening and the drive-use opening are communicated with each other, by which the transmission mechanism is engaged with a holding frame for the lens groups.

According to the production method for an imaging device according to this invention, an imaging device which is capable of reducing its size, price and noise and moving the lenses with high precision can be assembled with simplicity. Also, since the lens housing and the drive housing are separable from each other, reworking of the imaging device can be performed with simplicity.

### BRIEF DESCRIPTION OF DRAWINGS

FIG. 1 is a perspective view showing an imaging device according to an embodiment of the invention in an unassembled state thereof;

FIG. 2 is a perspective view showing a schematic construction of the imaging device after its assembly;

FIG. 3 is a perspective view showing a state in which a lens housing constituting the imaging device is in a wide position, as viewed along a direction other than in FIG. 1;

FIG. 4 is a perspective view showing a state in which the lens housing constituting the imaging device is in a telescopic position, as viewed along the same direction as in FIG. 3;

FIG. 5 is a view showing elements mounted on the drive mechanism constituting the imaging device;

FIG. 6 is a process view for explaining assembling steps of the imaging device; and

FIG. 7 is another process view for explaining assembling steps of the imaging device.

### DESCRIPTION OF EMBODIMENTS

Hereinbelow, the present invention will be described in detail by way of embodiments thereof illustrated in the accompanying drawings.

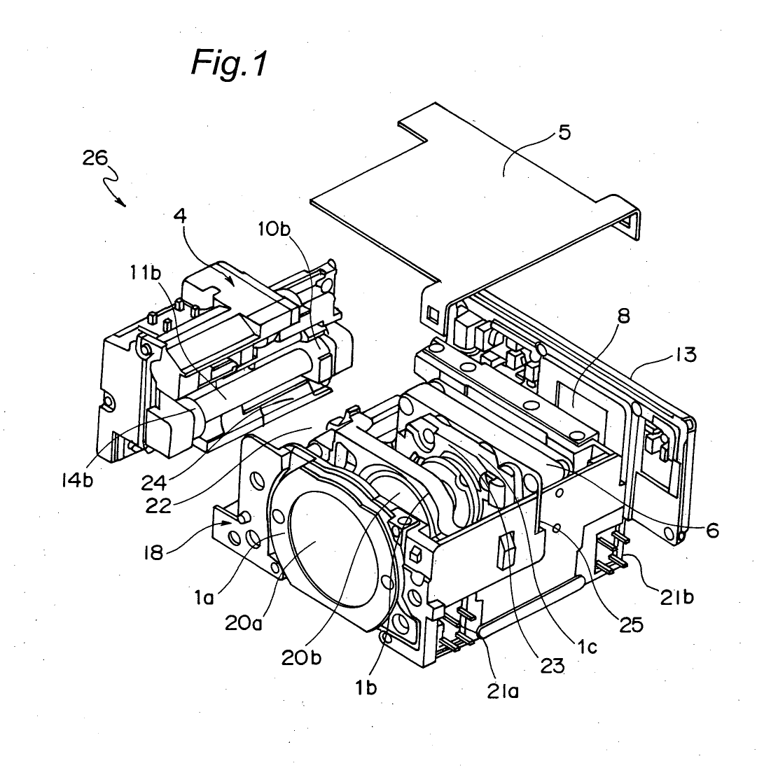

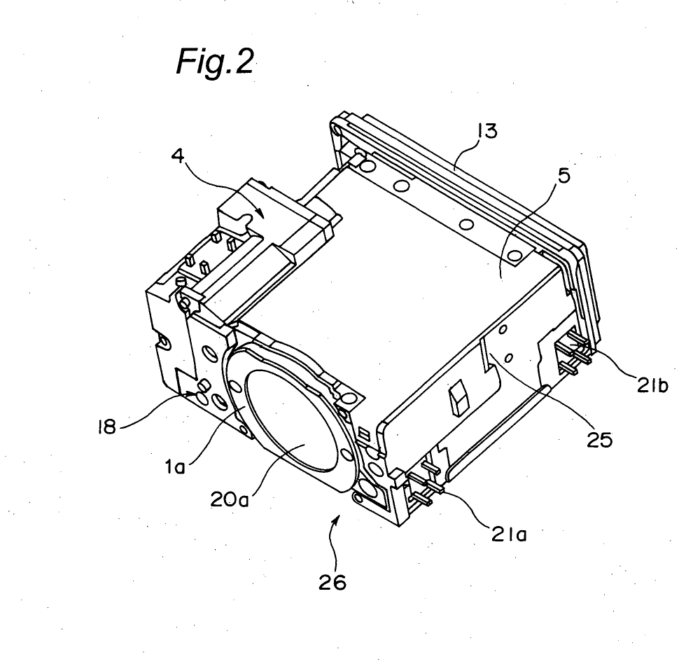

FIG. 1 is a perspective view of an imaging device in an unassembled state thereof (totally indicated by reference sign 26) according to an embodiment of the invention. This imaging device 26 roughly includes a lens housing 18 on which a plurality of lens groups 20a-20d, a mechanical shutter 6 and the like are mounted, a drive housing 4 on which a drive source and a transmission mechanism for driving the lens groups in an optical axis direction thereof are mounted, an image pickup board 13 having an image sensor 8 mounted thereon, and a top plate 5 as a plate member. As will be described later, the imaging device 26 is assembled by fitting the drive housing 4, the image pickup board 13 and the top plate 5 to the lens housing 18. Thus, such an imaging device 26 as shown in FIG. 2 is completed (FIG. 2 is a schematic view in which a later-described flexible printed circuit board (FPC) is omitted).

As can be seen from FIG. 1, the lens housing 18 has, on its one side for mounting of the drive housing 4, a first opening 22 opened along the optical axis direction of the lens groups 20a-20d. The lens housing 18 also has, on its one side for mounting of the top plate 5, a second opening 23 so as to allow inside of the lens housing 18 to be observed from outside. The drive housing 4 has a driving-use opening 24 to be communicated with the first opening 22 of the lens housing 18.

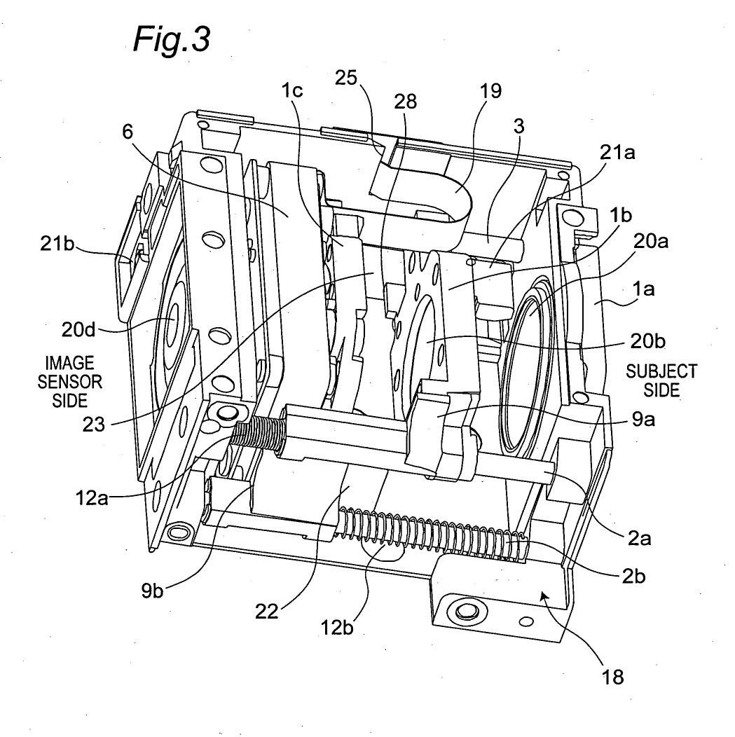

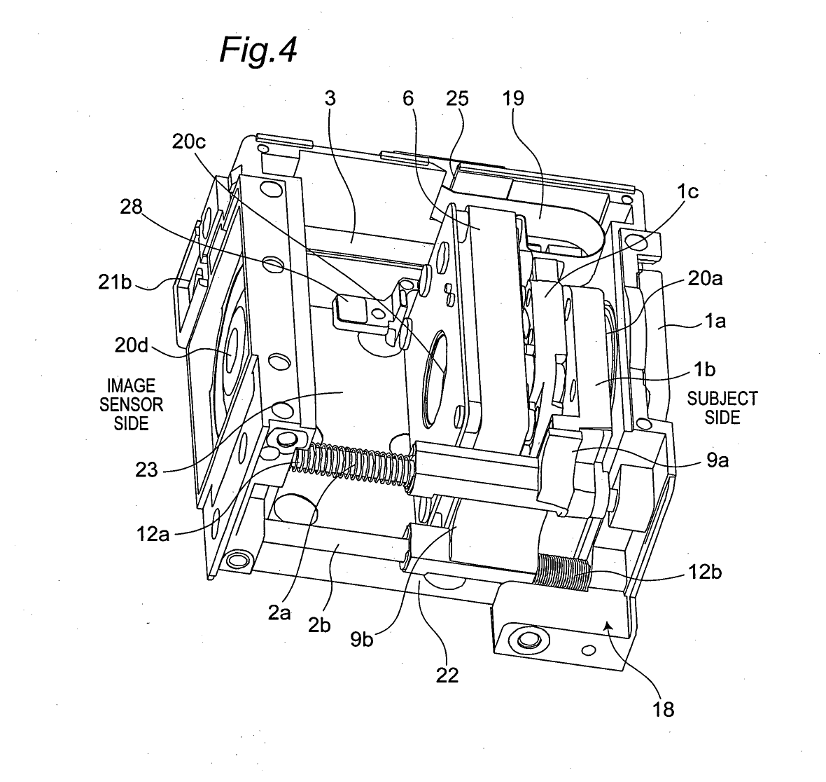

FIGS. 3 and 4 show an internal construction of the lens housing 18. FIGS. 3 and 4 show states in a wide position (wide angle position) and a telescopic position, respectively.

Four lens groups comprised of a first group lens 20a, a second group lens 20b, a third group lens 20c and a fourth group lens 20d are mounted in line on the lens housing 18 so as to have one optical axis in common. The first group lens 20a and the fourth group lens 20d are fixed at positions opposite to each other on the lens housing 18.

The second group lens 20b and the third group lens 20c placed between the first group lens 20a and the fourth group lens 20d are fitted to a second group lens holder 1b and a third group lens holder 1c, respectively. The second group lens holder 1b and the third group lens holder 1c together with the second group lens 20b and the third group lens 20c, respectively, are guided by guide shafts 2a, 2b and a sub shaft 3, being movable in the optical axis direction. Movement of these second group lens 20b and third group lens 20c in the optical axis direction allows the imaging optical system to be varied in image pickup magnification (zooming) or to be focused (focusing).

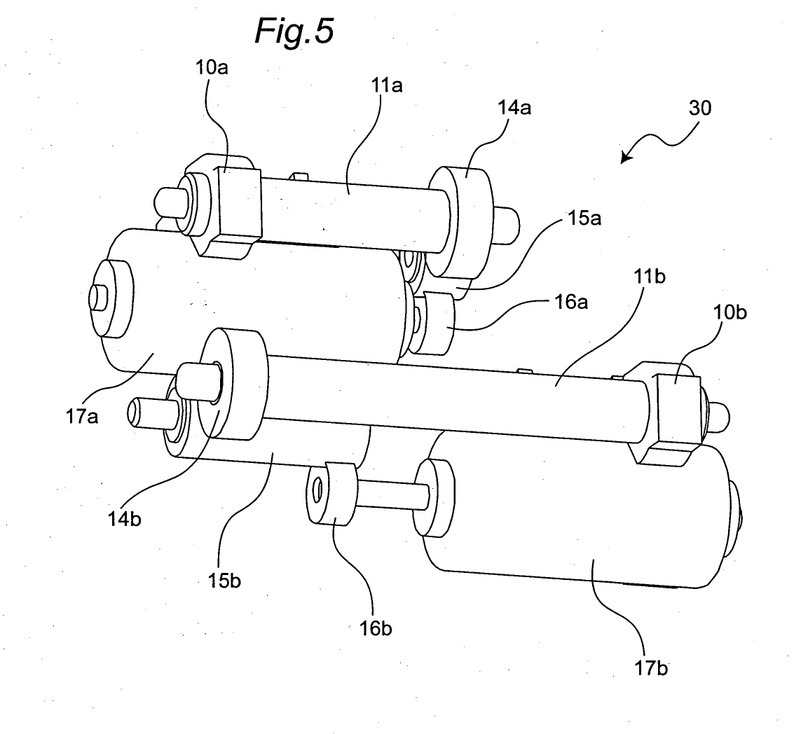

The guide shafts 2a, 2b and the sub shaft 3 are inserted into bearing portions and a sub bearing portion for each of the second group lens holder 1b and the third group lens holder 1c. Both ends of the guide shafts 2a, 2b and the sub shaft 3 are each fixed to the lens housing 18. Preloading springs 12a, 12b formed of compression coil springs (helical springs) are provided so as to surround outer peripheries of the guide shafts 2a, 2b, respectively. The preloading springs 12a, 12b are placed between the bearing portions of the second group lens holder 1b and the third group lens holder 1c, respectively, and a wall surface of the lens housing 18. The preloading springs 12a, 12b expand and contract to bias the second group lens holder 1b and the third group lens holder 1c toward nuts 10a, 10b (see FIG. 5) set on the drive housing 4, respectively, thereby absorbing rattles in thrust directions.

The mechanical shutter 6 for adjusting light quantity in response to a brightness of a subject is screwed and fixed to the third group lens holder 1c. The mechanical shutter 6 moves in the optical axis direction together with the third group lens holder 1c. To this mechanical shutter 6 is connected a control-use flexible printed circuit board (hereinafter, referred to as “control FPC”) 19 for feeding power to a drive section (not shown) which serves to open and close a shutter blade of the mechanical shutter 6 or an ND filter (aperture). The control FPC 19 has an expanding-and-contracting portion that varies in configuration (U-shaped portion) as shown in FIGS. 3 and 4 along with movement of the third group lens holder 1c in the optical axis direction. This expanding-and-contracting portion is a movable portion of the control FPC 19. The expanding-and-contracting portion (U-shaped portion) of the control FPC 19 that varies in configuration is placed inside the lens housing 18. Then, a portion of the control FPC 19 corresponding to one side of its expanding-and-contracting portion (U-shaped portion), which is an opposite side of the mechanical shutter 6, is led outside through a slit 25 provided on a side of the lens housing 18 opposite to the first opening 22. The expanding-and-contracting portion (U-shaped portion) of the control FPC 19 is also placed on the side of the lens housing 18 opposite to the first opening 22. Providing the expanding-and-contracting portion (U-shaped portion) in the control FPC 19 allows the third group lens holder 1c to be moved smoothly (with smaller loads) so that a stable drive is enabled.

In the second group lens holder 1b and the third group lens holder 1c, a flag 28 that passes through photo interrupters (origin sensors) 21a, 21b is formed. Positions of the second group lens holder 1b and the third group lens holder 1c are detected by those origin sensors 21a, 21b. In addition, the control FPC 19 for the mechanical shutter 6 serves also as an FPC for detecting outputs of the origin sensors 21a, 21b. That is, FPCs for performing control and power feed for members placed within the lens housing 18 are integrated into one FPC. As a result, leading work for the FPC can be easily achieved.

FIG. 5 shows an internal construction of the drive housing 4. On the drive housing 4 are mounted drive sources 17a, 17b and a transmission mechanism 30 for driving the second group lens holder 1b and the third group lens holder 1c.

Rotation of a first motor 17a formed of a stepping motor or the like as a drive source is transmitted via a motor pinion 16a, a reduction gear 15a and a lead screw gear 14a, by which a lead screw 11a is rotated so that the nut 10a screwed to a male screw portion of the lead screw 11a is driven. Similarly, rotation of a second motor 17b formed of a stepping motor or the like as a drive source is transmitted via a motor pinion 16b, a reduction gear 15b and a lead screw gear 14b, by which a lead screw 11b is rotated so that the nut 10b screwed to a male screw portion of the lead screw 11b is driven.

These motor pinions 16a, 16b, the reduction gears 15a, 15b, the lead screw gears 14a, 14b, the lead screws 11a, 11b and the nuts 10a, 10b constitute the transmission mechanism 30 for transmitting driving force derived from the drive sources 17a, 17b to the lens groups.

As shown in FIGS. 3 and 4, nut contact portions 9a, 9b to be in contact with the nuts 10 are formed in part of the second group lens holder 1b and the third group lens holder 1c. As the lead screw gear 14a is rotated by the motor 17a shown in FIG. 5, the nut 10a together with the nut contact portion 9a shown in FIGS. 3 and 4 moves along the lead screw 11a. As a result, the second group lens holder 1b biased by the preloading spring 12a is guided by the guide shafts 2a, 2b and the sub shaft 3 so as to move in the optical axis direction. Similarly, as the lead screw gear 14b is rotated by the motor 17b shown in FIG. 5, the nut 10b together with the nut contact portion 9b shown in FIGS. 3 and 4 moves along the lead screw 11b. As a result, the third group lens holder 1c biased by the preloading spring 12b is guided by the guide shafts 2a, 2b and the sub shaft 3 so as to move in the optical axis direction.

Although this embodiment is shown on a case in which two drive sources are provided, operations go likewise also when one drive source is provided.

In the case of two drive sources (motors 17a, 17b) as in this embodiment, the two motors 17a, 17b are preferably apposed along the optical axis direction so that the motors 17a, 17b do not overlap with each other as shown in FIG. 5. Such placement allows the drive housing 4 to be downsized in a direction vertical to the optical axis direction, contributing to a space saving. In the imaging device 26 of this invention, by virtue of a configuration that the drive housing 4 is placed in a direction vertical to the optical axis of the lens housing 18 as will be described later, such placement of the motors 17a, 17b as described above makes it possible to downsize the imaging device 26.

Next, an assembling procedure for the imaging device 26 will be described.

As described in conjunction with FIG. 1, the imaging device 26 is assembled by fitting the drive housing 4, the image pickup board 13 and the top plate 5 to the lens housing 18, and by thereafter doing leading and fitting of individual FPCs.

Prior to the assembling, optical members such as the individual lens groups 20a-20d, the mechanical shutter 6, the origin sensors 21a, 21b and the guide shafts 2a, 2b are preliminarily mounted on the lens housing 18. Needless to say, these optical members should be placed with high precision. In this embodiment, all the optical members necessary to make up the imaging device 26 are preliminarily mounted on the lens housing 18, which facilitates high-precision placement of the individual optical members. On the other hand, the motors 17a, 17b as drive sources and the transmission mechanism 30 such as the lead screws 11 are all placed in the drive housing 4 as described in conjunction with FIG. 5. Thus, all the components that fulfill optical functions are mounted on the lens housing 18, while all the components that fulfill drive functions are mounted on the drive housing 4.

As described in conjunction with FIG. 1, the lens housing 18 has the first opening 22 in a direction extending along the optical axis on a placement side of the drive housing 4, and the second opening 23 on a placement side of the top plate 5. That is, the lens housing 18 is formed into a rectangular box shape in which two faces out of its six faces are opened. Meanwhile, the drive housing 4 is provided with a drive-use opening 24 on only one side on which the lens housing 18 is placed.

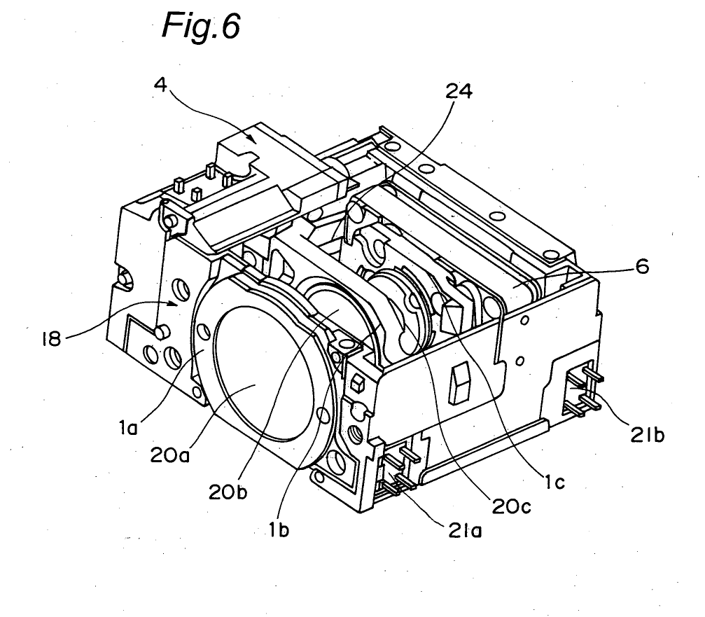

First, the lens housing 18 and the drive housing 4 are separably fitted to each other so that the first opening 22 of the lens housing 18 and the drive-use opening 24 of the drive housing 4 are communicated with each other. The fitting of the lens housing 18 and the drive housing 4 is fulfilled by joining portions of the two housings 18, 4 with screws or adhesive. With the lens housing 18 and the drive housing 4 combined together, the first opening 22 and the drive-use opening 24 become invisible from outside as shown in FIG. 6, resulting in a state that the second opening 23 alone is opened outward.

At this stage, a good/no-good evaluation is performed as to whether drive characteristics of the second group lens holder 1b and the third group lens holder 1c, as well as characteristics of the optical system, are good or no good. In this case, if the characteristics are evaluated as no good, the drive housing 4 and the lens housing 18 are separated from each other, and only a failed-side one of the housings is replaced. Before fitting of the top plate 5, inside of the lens housing 18 can be observed from outside of the lens housing 18 through the second opening 23, so that good or no-good of drive characteristics can be easily confirmed. If the drive characteristics are problematic, reworking is done. Thus, reworking is carried out with ease.

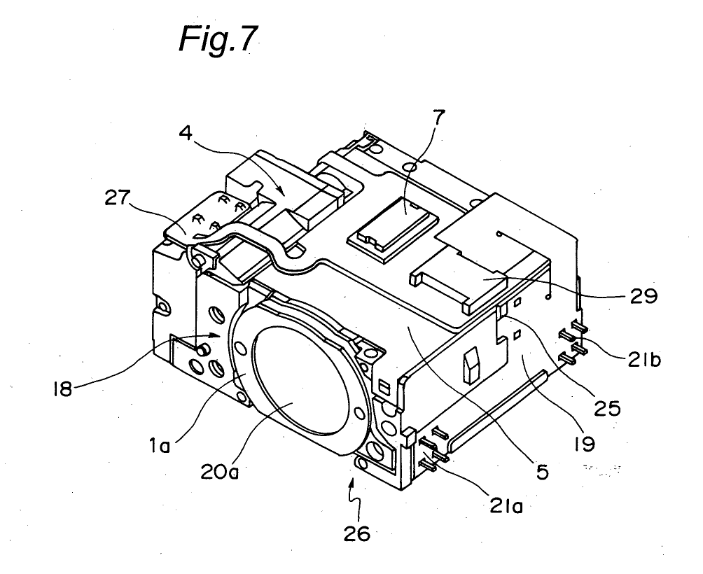

Without any problem in characteristics, the top plate 5 is fitted to the lens housing 18 so as to close the second opening 23 as shown in FIG. 7. The fitting of the top plate 5 to the lens housing 18 is done by fixation using fitting claws or by adhesion.

Next, fitting of the FPC 19 for the mechanical shutter 6 and the origin sensors 21a, 21b, and fitting of a drive-use flexible printed circuit board (hereinafter, referred to as “drive FPC”) 27 for feeding power to the motors 17a, 17b, are carried out. The drive FPC 27 is electrically joined (soldered) to the motors 17a, 17b, which are drive sources inside the drive housing 4. A control connector 29 as a connecting-use connector is placed in the drive FPC 27, and the control connector 29 is adhesively fixed along an outer surface (top surface) of the top plate 5 via the drive FPC 27 with an aid of double-sided adhesive or the like. The control connector 29 allows the control FPC 19 to be fitted thereto and removed therefrom, and the drive FPC 27 and the control FPC 19 are electrically connected to each other by the control connector 29, so that total control is enabled finally through a main connector 7 serving as a junction-use connector. The drive FPC 27 is placed so as to stretch over the lens housing 18 and the drive housing 4.

At this stage, a good/no-good evaluation of drive characteristics or the optical system may be performed again. Connector failures or interconnect failures that have not proved in the previous evaluation can be checked. If any problem exists in the drive characteristics (drive housing 4) or the optical characteristics (lens housing 18), reworking is performed. Since the control connector 29 is fittable and removable, removing the control FPC 19 allows the interconnections to be easily separated. Also, since the control connector 29 is fixed to the top plate 5, removing this fixation and replacing the top plate 5 with another allows the drive housing 4 and the lens housing 18 to be separated from each other without causing any damage thereon. The top plate 5 is a simple plate member and low-priced in comparison with the drive housing 4 and the lens housing 18, allowing the reworking to be achieved at low cost.

Finally, the image pickup board 13 is fitted to the lens housing 18 (see FIG. 2). In this way, this imaging device 26 is assembled with simplicity.

Preferably, the top plate 5 is made by using metallic material. The control connector 29 and the main connector 7, which are placed on the top plate as described above, undergo loads during their connection and, therefore, are preferably formed from a metal having higher rigidity than resin or the like. For example, a thin plate (about 0.2 to 0.5 mm thick) of stainless, aluminum or the like may be used. This provides a secondary effect that its thickness can be made thinner than that of resin materials, so that the imaging device can be downsized.

As can well be understood by FIG. 7, the control FPC 19 for the mechanical shutter 6 and the origin sensors 21a, 21b is drawn outside through the slit 25 provided on one side of the lens housing 18 opposite to the first opening 22 side (as already described). Accordingly, at this production stage of the imaging device 26, when the lens housing 18 and the drive housing 4 are combined together, the control FPC 19 makes no obstacle to the assembling work. Also, since the drive housing 4 (as well as members mounted thereon) is not placed on the side of the lens housing 18 opposite to the first opening 22 side, there is a space essentially for placement of such members as the control FPC 19. Therefore, in this imaging device 26, such a space is effectively exploited, making it easier to downsize the imaging device.

Since the optical function and the drive function are independently assigned to the lens housing 18 and the drive housing 4, respectively, as described before, there is another advantage that reworking is facilitated by, for example, integrating the control FPC 19 for the mechanical shutter 6 on the lens housing 18 side.

Since the control FPC 19 is deformed at the zoom position as described in conjunction with FIGS. 2 and 3, by placing the control FPC 19 on a wide placement space side opposite to the side of placement of the drive housing 4, it becomes possible to use the space effectively. From similar reasons, the origin sensors 21a, 21b are also preferably placed on the side of the optical axis opposite to the side on which the drive housing 4 is placed.

As can well be understood by FIG. 1, in the imaging device 26, the drive housing 4 is formed into a configuration that only one face out of its six faces, i.e. its drive-use opening 24 side alone, is opened. Generally, the motors 17a, 17b and their transmission mechanism 30 (see FIG. 5) tend to be vibration sources to cause drive noise and lens vibrations, incurring performance deterioration of the imaging device. Particularly when the drive-source motors 17a, 17b and the transmission mechanism 30 are placed in a member corresponding to the lens housing 18 as in the prior art, drive noise tends to be high and lens vibrations as well become more likely to occur, because of direct transfer of vibrations to the lens housing 18 and contribution of the transfer in all the directions around the motors 17a, 17b and the transmission mechanism 30. In contrast, in this imaging device 26, it becomes easier to achieve reduction of drive noise and suppression of lens vibrations, because the motors 17a, 17b and the transmission mechanism 30 that are vibration sources are internally contained in the drive housing 4, those vibration-source members are coupled to the lens housing 18 via the drive housing 4, and because the drive housing 4 is opened in one direction only.

Therefore, containing vibration sources inside the drive housing 4 makes it possible to suppress the transfer of noise to the outside. Also, fitting the vibration sources to the lens housing 18 via the drive housing 4 makes it easier to do the fitting to the lens housing 18 at less vibration-transferable places of the drive housing 4, so that drive noise and lens vibrations can be suppressed. The terms “less vibration-transferable places” refer to, for example, places away from places of the drive housing 4 where the motors 17a, 17b and the lead screws 11a, 11b are fixed. Such places in the drive housing 4 are preferably fitted to the lens housing 18.

In the stage that the top plate 5 has been fitted to the lens housing 18 as shown in FIG. 7, a closed structure is made up by the lens housing 18, the drive housing 4 and the top plate 5 in a state that the mutually communicated first opening 22 and drive-use opening 24 are surrounded. Thus, invasion of contaminations from outside to inside of the imaging device 26 can be easily prevented.

If the motors 17a, 17b and the transmission mechanism 30 were fitted to outside of an opened lens housing 18, reworking would become easy to do, but reduction of drive noise and invasion of contaminations would become difficult to achieve.

The present invention is not limited to the above-described imaging device 26, but also applicable to, for example, imaging devices having an optical system other than the above-described one.

As described above, the imaging device of the invention is capable of reducing its size, price and noise, moving the lens groups with high precision, and facilitating its assembly and reworking.

1. An imaging device comprising:
a lens housing on which lens groups are mounted and which has a first opening opened along an optical axis direction of the lens groups; and
a drive housing on which a drive source for moving the lens groups in the optical axis direction is mounted and which has a drive-use opening to be communicated with the first opening of the lens housing, wherein
the lens housing and the drive housing are combined together so as to be separable from each other in a state that the first opening and the drive-use opening are communicated with each other.

2. The imaging device as claimed in claim 1, wherein
in addition to the drive source, a transmission mechanism for transmitting driving force derived from the drive source to the lens groups is mounted on the drive housing.

3. The imaging device as claimed in claim 2, wherein
the drive source and the transmission mechanism are internally contained in the drive housing.

4. The imaging device as claimed in claim 1, wherein
the lens housing has, in addition to the first opening, a second opening which allows inside of the lens housing to be observed, and
a removable plate member for closing the second opening is included.

5. The imaging device as claimed in claim 1, wherein
the lens groups include at least two lens groups enabled to move along the optical axis direction independently of each other,
the drive source includes first and second motors for moving the two lens groups, respectively, along the optical axis direction independently of each other, and
the first motor and the second motor are apposed along the optical axis direction on the drive housing.

6. The imaging device as claimed in claim 1, wherein
a mechanical shutter for adjusting light quantity in response to a brightness of a subject is mounted on the lens housing, and
a control-use flexible printed circuit board for feeding power to the mechanical shutter is drawn out of the lens housing from one side of the lens housing opposite to a first opening side with respect to the optical axis of the lens groups.

7. The imaging device as claimed in claim 6, wherein
the control-use flexible printed circuit board for feeding power to the mechanical shutter has an expanding-and-contracting portion which is deformed as one of the lens groups moves in the optical axis direction, and the expanding-and-contracting portion is placed within the lens housing on one side of the lens housing opposite to a first opening side with respect to the optical axis of the lens groups.

8. The imaging device as claimed in claim 1, wherein
an origin sensor for detecting a position of the lens groups is mounted on one side of the lens housing opposite to a first opening side with respect to the optical axis of the lens groups.

9. The imaging device as claimed in claim 6, wherein
an origin sensor for detecting a position of the lens groups is mounted on one side of the lens housing opposite to a first opening side with respect to the optical axis of the lens groups, and
the control-use flexible printed circuit board for feeding power to the mechanical shutter includes a flexible printed circuit board for feeding power to the origin sensor.

10. The imaging device as claimed in claim 6, wherein
a drive-use flexible printed circuit board for feeding power to the drive source is connected to the control-use flexible printed circuit board via a removable connecting-use connector.

11. The imaging device as claimed in claim 10, wherein
the lens housing has, in addition to the first opening, a second opening which allows inside of the lens housing to be observed,
a removable plate member for closing the second opening is included, and
the removable connecting-use connector is placed along an outer surface of the plate member.

12. The imaging device as claimed in claim 11, wherein
the plate member is formed from a metallic material.

13. A method for producing an imaging device comprising:
preparing a lens housing on which lens groups are mounted and which has a first opening opened along an optical axis direction of the lens groups, and
a drive housing on which a drive source for moving the lens groups in the optical axis direction and a transmission mechanism for transmitting driving force derived from the drive source to the lens groups are mounted and which has a drive-use opening to be communicated with the first opening of the lens housing; and
combining the lens housing and the drive housing together separably from each other in a state that the first opening and the drive-use opening are communicated with each other, by which the transmission mechanism is engaged with a holding frame for the lens groups.
